(19) United States
(12) Patent Application Publication
(10) Pub. No.: US 2014/0366129 A1
(43) Pub. Date: Dec. 11, 2014

(54) ELECTRIC DEVICE, ANOTHER ELECTRIC DEVICE, METHOD OF CONTROLLING ELECTRIC DEVICE AND COMPUTER-READABLE MEDIUM FOR CONTROLLING ELECTRIC DEVICE

(71) Applicant: KABUSHIKI KAISHA TOSHIBA, TOKYO (JP)

(72) Inventors: Kazuki Kimura, Fussa-shi (JP); Terunobu Hara, Ome-shi (US)

(73) Assignee: KABUSHIKI KAISHA TOSHIBA, TOKYO (JP)

(21) Appl. No.: 14/209,590

(22) Filed: Mar. 13, 2014

(30) Foreign Application Priority Data
Jun. 5, 2013 (JP) 2013-119209

(51) Int. Cl. G06F 21/32; G06K 7/14

(52) U.S. Cl. CPC G06F 21/32; G06K 7/1417
USPC 726/19; 235/462.11

(57) ABSTRACT

An electric device includes an imaging module, a detector and an output module. The imaging module takes an image which is output from another electric device. The detector detects a code designation from data of the image taken by the imaging module. The output module generates another code designation which is different from the code designation which is output from said another electric device, and outputs said another code designation to said another electric device, when the detector detects the code designation which is output from said another electric device.

### CROSS-REFERENCE TO RELATED APPLICATION(S)

This application is based upon and claims the benefit of priority from Japanese Patent Application No. 2013-119209, filed on Jun. 5, 2013; the entire contents of which are incorporated herein by reference.

### FIELD

Embodiments described herein relate generally to an electric device, another electric device, a method of controlling the electric device, and a computer-readable medium for controlling the electric device.

### BACKGROUND

In recent years, electric devices such as personal computers (PCs) have become widely used, and a security level improvement has been demanded.

For example, in the electric devices such as PCs, a method of locking the electric device against other users, which utilizes a password or the like, is used in order to improve the security level.

Specifically, a method of unlocking the electric device for a particular user upon receiving a predetermined password from the user is used.

In addition, the locking can be strengthened by using, for example, plural passwords or a complicated password, thereby to further improve the security level.

However, it is generally cumbersome and inconvenient that a user has to manage the plural passwords or a complicated password when using the electric devices.

Therefore, an electric device that is capable of reducing cumbersomeness experienced by the user and improving a security level has been desired to be provided.

### BRIEF DESCRIPTION OF THE DRAWINGS

FIG. 1 is a view illustrating appearances of a first electric device and a second electric device according to an embodiment.

FIG. 2 is a block diagram for explaining a configuration of the first electric device according to the embodiment.

FIG. 3 is a flowchart for explaining an operation of the first electric device.

FIG. 4 is an explanatory view for explaining a message that requests a user to input a password (unlock code), the message being displayed on a display of the first electric device.

### DETAILED DESCRIPTION

According to one embodiment, an electric device includes an imaging module; a detector and an output module. The imaging module takes an image which is output from another electric device. The detector detects a code designation from data of the image taken by the imaging module. The output module generates another code designation which is different from the code designation which is output from said another electric device, and outputs said another code designation to said another electric device, when the detector detects the code designation which is output from said another electric device.

Various embodiments will be described hereinafter with reference to the accompanying drawings.

In the following, embodiments according to the present invention will be explained with reference to the accompanying drawings.

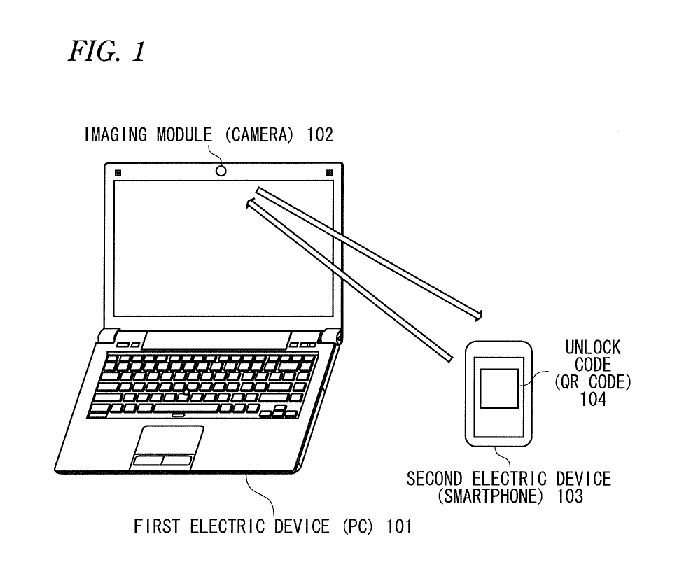

FIG. 1 illustrates appearances of a first electric device and a second electric device according to an embodiment.

In this embodiment, a first electric device (PC) 101 is provided with an imaging module (camera) 102.

In addition, the first electric device (PC) 101 is provided with a detector (not illustrated in FIG. 1). The detector detects a code designation (unlock cord) 104, which has been output from a second electric device (smartphone) 103, from image data taken by the imaging module (camera) 102.

Here, as one example of the code designation, a QR code (Registered Trademark) or the like may be used in this embodiment.

In addition, the first electric device (PC) 101 is provided with an output module (not illustrated in FIG. 1). The output module outputs data of another code designation different from the detected code designation when the code designation is detected.

The first electric device (PC) 101 and the second electric device (smartphone) 103 can communicate with each other, for example, by radio communications wire communications, or the like.

For example, when the first electric device (PC) 101 detects the code designation (unlock code) 104 that has been output from the second electric device (smartphone) 103, a new code designation, which is different from the detected code designation, is generated. Then, the new code designation is transmitted (output) toward the second electric device (smartphone) 103 from the first electric device (PC) 101.

Namely, in this embodiment, the first electric device (PC) 101 detects the code designation (unlock code) 104 that has been output from the second electric device (smartphone) 103, and performs using the code designation 104 an authentication procedure (authentication of the code designation 104) that is substantially the same authentication as a password authentication procedure.

Here, the QR code (Registered Trademark) is explained.

The QR code (Registered Trademark) is a two dimensional code of a matrix type, developed by DENSO CORPORATION. In this embodiment, the QR code (Registered Trademark) is used as an example of the code designation (unlock code) 104. However, the code designation (unlock code) 104 is not limited to the QR code (Registered Trademark), as long as the code designation (unlock code) 104 is displayed in the second electronic device (smartphone) 103.

In addition, the QR code (Registered Trademark) is a registered trademark of DENSO WAVE INCORPORATE.

While, for example, a bar code stores data only in a transverse direction thereof, the QR code (Registered Trademark) stores data in both vertical and horizontal directions. Therefore, the QR code (Registered Trademark) is advantageous in that a larger amount of data can be stored. For example, not only numeral but also multilingual data such as English characters and Chinese Characters can be stored by the QR cade (Registered Trademark).

In addition, a “QR” of the QR code (Registered Trademark) comes from “Quick Response”, which means that high speed reading is feasible. The QR code (Registered Trademark) was developed with the prospect of usage in an automobile factory, a delivery center, or the like at the beginning. However, the QR code (Registered Trademark) has become widely used worldwide due to a widespread usage of a smartphone or the like.

In this embodiment, after the code designation 104 is authenticated, the first electric device (PC) 101 generates a new code designation that is different from the code designation 104 that has been originally output from the second electric device (smartphone) 103, and transmits the new code to the second electric device (smartphone) 103, which is capable of improving a security level.

In addition, in this embodiment, password unlocking (the code designation authentication and password unlocking) based on the code designation (unlock code) 104 is validated in the first electric device (PC) 101. In this case, when the user is requested to input a password, for example, the imaging module (camera) 102 may be activated and the authentication of the code designation (unlock code) 104 may be performed.

In addition, in this embodiment, for example, near field communications may be utilized in data transmission of the code designation (unlock code) 104.

Moreover, when the data transmissions or the like are failed, the code designation (unlock code) 104 can be kept unchanged, for example.

Incidentally, although the personal computer (PC) is exemplified as the first electric device 101 and the smartphone is exemplified as the second electric device 103 in this embodiment. The first electric device 101 may be a tablet PC, a smartphone, a television set, or the like, and the second electric device 103 may be a mobile device including a tablet PC or the like in other embodiments.

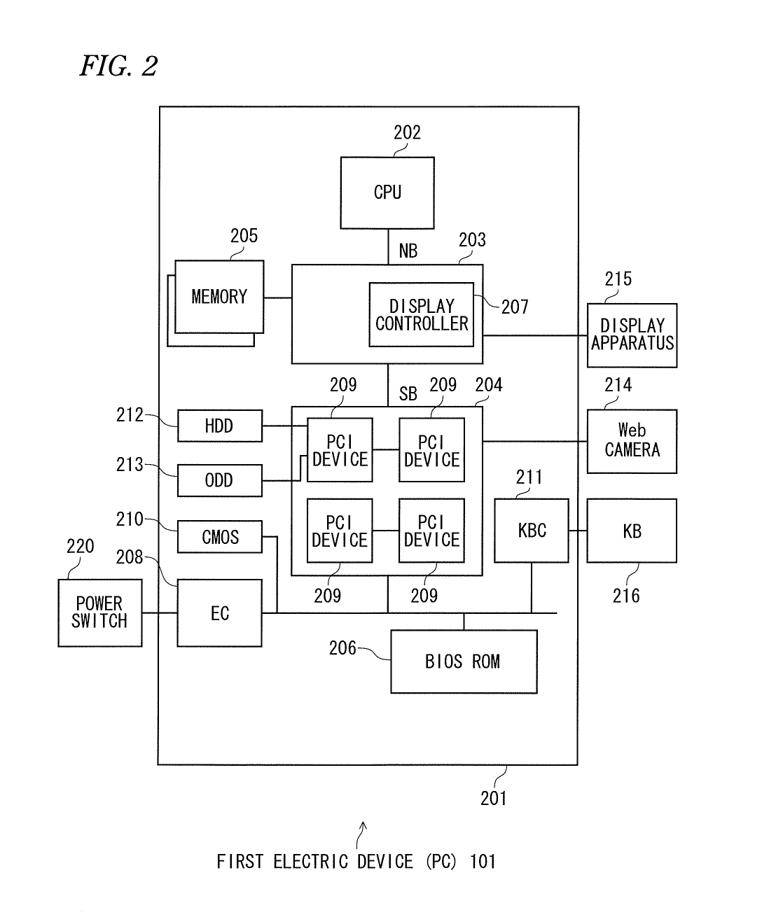

FIG. 2 is a block diagram for explaining a configuration of an electric device according to this embodiment.

Referring to FIG. 2, the first electric device (PC) 101 is provided with, for example, a central processing unit (CPU) 202, a North Bride 203, a South Bridge 204, a memory 205, a BIOS ROM 206, a display controller 207, an EC 208, an SATA controller 209, a CMOS 210, a Keyboard Controller (KBC) 211, a Hard Disc Drive (HDD) 212, an Optical Disc Drive (ODD) 213, a Web camera 214, a display 215, a Keyboard (KB) 216, and a power switch 220.

Specifically, the central processing unit (CPU) 202, the North Bride 203, the South Bridge 204, the memory 205, the BIOS ROM 206, the display controller 207, the EC 208, the SATA controller 209, the CMOS 210, the Keyboard Controller (KBC) 211, the Hard Disc Drive (HDD) 212, and the Optical Disc Drive (ODD) 213 are arranged inside a PC body 201; and the Web camera 214, the display 215, the Keyboard (KB) 216, and the power switch 220 are connected to the PC body 201.

Here, the CPU 202 is, for example, a primary processing unit; the North Bridge 203 is a chip that is responsible mainly for a memory control and a display-related control; and the South Bridge 204 is a chip that is responsible mainly for controlling a PCI device, an LPC device or the like.

Programs such as BIOS and OS are laid out in the memory 205, and are executed.

A BIOS program that controls the PC and manages a processing in this embodiment is stored in the BIOS ROM 206.

In addition, the display 215 is connected to the display controller 207. The EC 208 manages a power control of the PC. The power switch 220 is connected to the EC 208.

The SATA controller 209 is a PCI device such as a USB controller or the like. The HDD 212, the ODD 213, a USB device (not illustrated), and the like are connected to the SATA controller 209.

The CMOS 20 stores data necessary at the time of activating the first electric device (PC) 101. The Keyboard (KB) 216 is connected to the Keyboard Controller (KBC) 211.

A Hard Disk Drive is connected to the HDD 212. In addition, an Optical Disc Drive is connected to the ODD 213.

Moreover, the first electric device (PC) 101 is provided with the Web camera 214, the display 215 such as an LCD, the KB (Keyboard) 216, and the power switch 220.

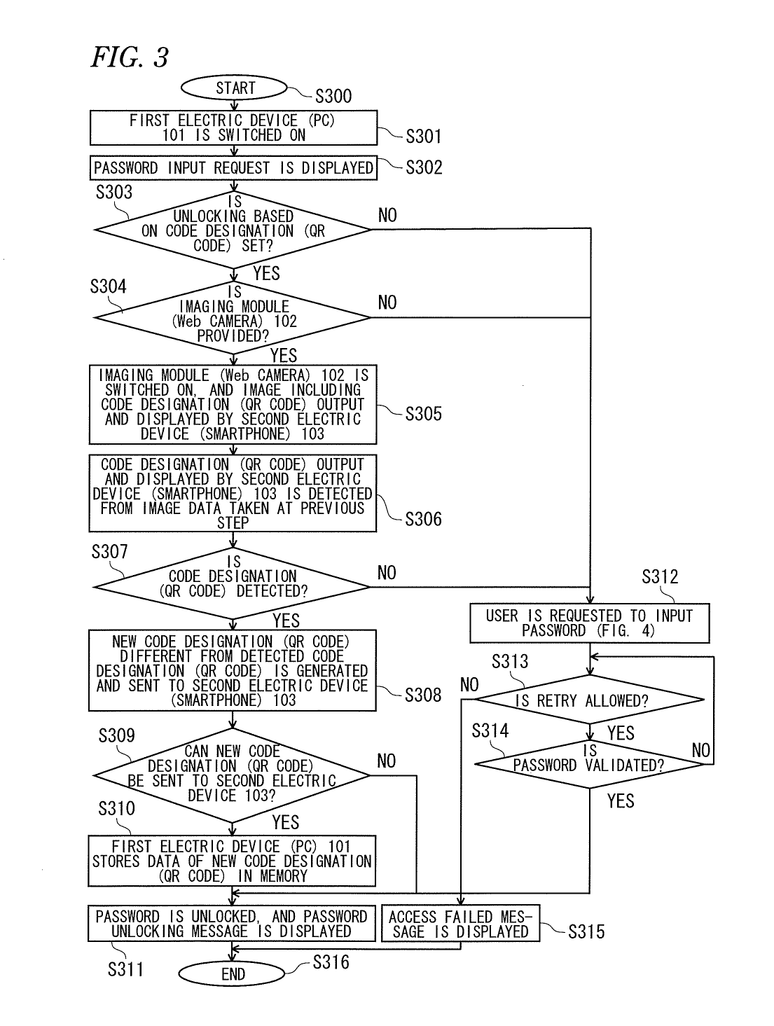

FIG. 3 is a flowchart for explaining an operation of the electric device according to this embodiment.

Step S300 is a start step, and the operation proceeds to Step S301 from here.

In Step S301, the first electric device (PC) 101 is switched ON. Then, the operation proceeds to Step S302.

In Step S302, a request for a user to input a password is displayed (password input request). Then, the operation proceeds to Step S303.

In Step S303, it is detected whether the unlocking based on a code designation (unlock code designation) has been set or not. When it is detected that the unlocking based on the code designation (unlock code designation) has been set, the operation proceeds to Step S304 (Step S303: Yes). When the unlocking based on the code designation (unlock code designation) has not been set, the operation proceeds to Step S312 (Step S303: No).

In Step S304, it is detected whether the imaging module (Web camera) 102 is provided or not. Instead, it may be detected whether the imaging module (Web camera) 102 is connected or not in this step.

When it is detected that the imaging module (Web camera) 102 is provided, the operation proceeds to Step S305 (Step S304: Yes). When it is detected that the imaging module (Web camera) 102 is not provided, the operation proceeds to Step S312 (Step S304: No).

In Step S305, the imaging module (Web camera) 102 is switched ON, and an image including the code designation (QR code or the like) that has been output from and displayed in the second electric device (smartphone) 103 is taken. Then, the operation proceeds to Step S306.

In Step S306, the code designation (unlock code designation) (unlock code designation) that has been output from and displayed in the second electric device (smartphone) 103 is detected from the image data taken in the previous step. Then, the operation proceeds to Step S307.

In Step S307, the first electric device (PC) 101 detects the code designation (unlock code designation) that has been output from and displayed in the second electric device (smartphone) 103.

When the first electric device (PC) 101 detects the code designation (unlock code designation) that has been output from and displayed in the second electric device (smartphone) 103, the operation proceeds to Step S308 (Step S307: Yes). When the first electric device (PC) 101 does not detect the code designation (unlock code designation) that has been output from and displayed in the second electric device (smartphone) 103, the operation proceeds to Step S312 (Step S307: No).

In Step S308, the first electric device (PC) 101 generates data of a new code designation (unlock code designation) that is different from the detected code designation (unlock code designation) that has been once output from the second electric device (smartphone) 103, and transmits the new code designation (unlock code designation) toward the second electric device (smartphone) 103. Subsequently, the operation proceeds to Step S309.

In step S309, it is detected whether the generated new code designation (unlock code designation) is transmitted to the second electric device (smartphone) 103.

When it is detected that the generated code designation (unlock code designation) is transmitted, the operation proceeds to Step S310 (Step S309: Yes). When it is detected that the generated code designation (unlock code designation) is not transmitted, the operation proceeds to Step S311 (Step S309: No).

In Step S310, the first electric device (PC) 101 stores the data of the new code designation (unlock code designation) in a storing module (for example, the memory 205 or the like). Then, the operation proceeds to Step S311.

In Step S311, the first electric device (PC) 101 is unlocked, and a password unlocking message is displayed on the displaying 215. Then, the operation proceeds to Step S316.

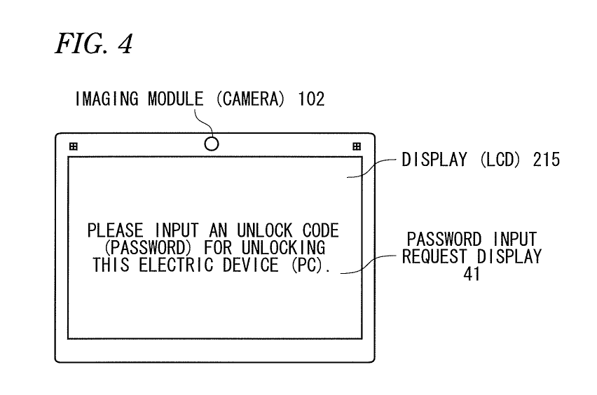

In Step S312, the first electric device (PC) 101 displays a message that requests the user to input a password, as illustrated in FIG. 4.

Here, FIG. 4 is explained.

FIG. 4 is a view for explaining the message that requests the user to input a password (unlock code), which is displayed in the display of the electric device according to this embodiment.

Referring to FIG. 4, a message of, for example, “Please input unlock code (password) for unlocking this electric device (PC)” is displayed on the displaying (LCD) 215 of the first electric device (PC) 101.

Subsequently, the operation proceeds to Step S313.

In Step S313, the number of times of input of the password by the user is detected. When the number of times does not exceed a predetermined number of times (for example, 3 times), it is determined that a retry is allowed. When the number of times exceeds a predetermined number of times, it is determined that no retry is allowed.

When the retry is allowed, the operation proceeds to Step S314 (Step S313: Yes), whereas the retry is not allowed, the operation proceeds to Step S315 (Step S313: No).

In Step S314, it is determined whether the password input by the user is validated. When it is determined that the password input by the user is validated, the operation proceeds to Step S311 (Step S314: Yes). When it is determined that the password input by the user is not validated, the operation returns to Step S313 (Step S314: No), and Steps 5313 and 5314 are repeated.

In Step S315, a “FAILURE” message is displayed, for example, in the display 215. Subsequently, the operation proceeds to Step S316.

In Step S316, the operation is terminated.

Namely, in this embodiment, for example, when the first electric device (PC) 101 is switched ON, the password input request to a user is issued.

Then, it is detected whether the password unlocking based on the code designation (unlock code) 104 (FIG. 1) has been set.

In addition, it is detected whether the imaging module (Web camera) 102 is provided.

When the imaging module (Web camera) 102 is provided, the imaging module (Web camera) 102 is switched ON, and the authentication of the code designation (unlock code) 104 is performed.

In a case of “No” in Step S303, Step S304, and Step S307, a conventional password unlocking is performed.

Then, the number of retries is detected. When the number of retries does not exceed a predetermined times, authentication of the password is performed, and thus it is determined whether the password is validated and whether the unlocking is carried out. On the other hand, when the number of retries exceeds the predetermined times, the “ACCESS FAILED” message is displayed, and the operation is terminated.

In addition, when the authentication of the code designation (unlock code) 104 (FIG. 1) is completed, a new code designation (for example, QR code (Registered Trademark)) is generated, and the generated new code designation (for example, QR code (Registered Trademark)) is sent to the second electric device (smartphone) 103.

Then, the first electric device (PC) 101 detects whether the new code designation (for example, QR code (Registered Trademark)) has been successfully sent. When the new code designation (for example, QR code (Registered Trademark)) has been successfully sent, the new code designation (the new code designation (for example, QR code (Registered Trademark)) is stored.

Then, unlocking (password unlocking) is performed for the first electric device (PC) 101. After this, an “unlocking completed (password unlocking completed)” message is displayed, and the operation is terminated.

As described above, in this embodiment, because the unlocking based on the code designation (unlock code) 104 is set and the password authentication is performed, a situation where the user, for example, forgets a password or accidentally inputs a wrong password can be prevented.

Therefore, while high security is maintained, it becomes further convenient for a user to manage and input the password.

In addition, in this embodiment, because the code designation (unlock code) 104 is changed every time when the authentication is performed, even if data of the code designation (unlock code) 104 is accidentally leaked, a risk that the first electric device (PC) 101 is casually unlocked can be reduced.

In addition, in this embodiment, because the unlocking can be realized only by reading the code designation (unlock code) 104, the user does not need to make an additional care. Namely, this embodiment can improve user friendliness.

In order to read the code designation (unlock code) 104, the first electric device (PC) 101 according to this embodiment is provided with the imaging module (camera) 102.

In addition, the first electric device (PC) 101 is provided with the detector (for example, the CPU 202) that detects the code designation (unlock code) 104, which has been output by the second electric device (smartphone) 103, from image data taken by the imaging module (camera) 102.

Moreover, the first electric device (PC) 101 is provided with the output module (for example, the CPU 202, North Bridge 203, or the like), which generates data of a code designation different from the code designation (unlock code) 104 that has been output by the second electric device (smartphone) 103 and outputs the same when the code designation is detected.

In addition, the first electric device (PC) 101 according to this embodiment detects whether the unlocking of the first electric device (PC) 101 based on the code designation is set. When such an unlocking is set, the code designation is detected by, for example, the CPU 202.

In addition, the first electric device (PC) 101 according to this embodiment is provided with an input requesting module (FIG. 4) that requests the user to input the password for unlocking, and an operation module (CPU 202, South Bridge 204, or the like) that operates the imaging module (camera) 102.

In addition, the first electric device (PC) 101 according to this embodiment is provided with the memory (memory 205) that stores data of the generated new code designation when the data of the generated new code designation is sent to the second electric device (smartphone) 103.

In addition, the first electric device (PC) 101 according to this embodiment is provided whit a password input module (FIG. 4) that requests the user to input the password when the code designation is detected.

Moreover, the first electric device (PC) 101 according to this embodiment is provided with a message output module (FIG. 3) that outputs the “ACCESS FAILED” message when the password inputting cannot be retried.

Furthermore, the second electric device (smartphone) 103 according to this embodiment receives and stores the data of the code designation sent from the first electric device (PC) 101, and outputs the stored data of the code designation is output in response to a predetermined handling by the user.

The above configurations in this embodiment can provide the first electric device 101 that can reduce cumbersomeness and inconvenience for the user and can provide high security.

Incidentally, the procedures of the operation according to this embodiment, described above, can be all executed by software. Therefore, a program for executing the procedures of the operation can be installed in a normal computer through a computer readable storage media that stores the program. So, the advantages of the above embodiment can be easily realized by running the computer to which the program is installed.

Incidentally, the above embodiment is not limited to the above descriptions, but may be realized through various changes in constituent elements without departing from the scope of the embodiment, at a stage of practicing the embodiment.

In addition, a plurality of constituent elements disclosed in the above embodiment may be arbitrarily combined thereby to embody various inventions.

Moreover, some constituent elements may be omitted from all the constituent elements illustrated in the embodiment. Furthermore, a constituent element(s) according to a different embodiment may be arbitrarily combined.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An electric device comprising:
an imaging module configured to take an image which is output from another electric device;
a detector configured to detect a code designation from data of the image taken by the imaging module; and
an output module configured to generate another code designation which is different from the code designation which is output from said another electric device, and to output said another code designation to said another electric device, when the detector detects the code designation which is output from said another electric device.

2. The electric device of claim 1,
wherein the detector detects whether unlocking is set in the electric device based on a code designation, and
wherein the detector detects the code designation which is output from said another electric device when the unlocking is set in the electric device.

3. The electric device of claim 2, further comprising:
an input requesting module configured to request an input for unlocking; and
an operating module configured to activate the imaging module when the unlocking is set in the electric device.

4. The electric device of claim 1, further comprising:
a memory configured to store data of the generated code designation, when the data of the generated code designation is sent to said another electric device.

5. The electric device of claim 1, further comprising:
a password input requesting module configured to request a user to input a password, when the detector does not detect the code designation which is output from said another electric device.

6. The electric device of claim 1, further comprising:
a message output module configured to output a failure message when retrying of inputting a password by a user is not allowed.

7. Another electric device configured to receive the data of said another code designation output from the electric device of claim 1, to store the received data of said another code designation, and to output the stored data of said another code designation in response to an operation by a user.

8. A method of controlling an electric device, comprising:
detecting a code designation from data of an image which is output from another electric device and which is taken by an imaging module;
generating another code designation which is different from the code designation which is output from said another electric device when the code designation which is output from said another electric device is detected; and
outputting said another code designation to said another electric device.

9. A non-transitory computer-readable medium storing a program that causes an electric apparatus to execute a control processing comprising:
detecting a code designation from data of an image which is output from another electric device and which is taken by an imaging module;
generating another code designation which is different from the code designation which is output from said another electric device when the code designation which is output from said another electric device is detected; and
outputting said another code designation to said another electric device.
